(19) United States
(12) Patent Application Publication
(10) Pub. No.: US 2024/0037336 A1
(43) Pub. Date: Feb. 1, 2024

(54) METHODS, SYSTEMS, AND MEDIA FOR BI-MODAL UNDERSTANDING OF NATURAL LANGUAGES AND NEURAL ARCHITECTURES

(71) Applicants: Mohammad AKBARI, Coquitlam (CA); Amin BANITALEBI DEHKORDI, Vancouver (CA); Behnam KAMRANIAN, North Vancouver (CA); Yong ZHANG, Richmond (CA)

(72) Inventors: Mohammad AKBARI, Coquitlam (CA); Amin BANITALEBI DEHKORDI, Vancouver (CA); Behnam KAMRANIAN, North Vancouver (CA); Yong ZHANG, Richmond (CA)

(21) Appl. No.: 17/877,742

(22) Filed: Jul. 29, 2022

(51) Int. Cl. G06F 40/284; G06N 3/04

(52) U.S. Cl. CPC G06F 40/284; G06N 3/0454

(57) ABSTRACT

Methods, systems, and computer-readable media for bi-modal understanding of natural language (NL) and artificial neural network architectures (NA), with reference to an example implementation framework entitled “ArchBERT”. A model and method of training the model for bi-modal understanding of NL and NA are described. The model trained in bi-modal understanding of NL and NA can be deployed to perform tasks such as processing NL to perform reasoning relating to NA, architectural question answering, architecture clone detection, bi-modal architecture clone detection, clone architecture search, and/or bi-modal clone architecture search.

### FIELD

The present disclosure relates to bi-modal machine learning, including bi-modal understanding of natural language and artificial neural network architectures.

### BACKGROUND

Most existing machine learning techniques are based on uni-modal learning, where only a single modality (i.e., a single type of data or datatype) is used as input for learning an inference task to be performed by a machine learning model. For example, an image classification model is typically trained using only images as data samples for training; a language translation model is typically trained using only text data samples. Despite the success of existing uni-modal learning techniques, they are insufficient to model some aspects of human inference behavior.

Some efforts have been made to address this problem by using multi-modal learning, wherein a model is configured and trained to jointly learn from multiple modalities of input data, such as two or more of: audio, video, image, text, etc. These approaches seek to impart to the model a better understanding of various senses (i.e. sensory modalities) in information processing. Some such approaches provide the possibility of supplying a missing modality based on the observed ones (e.g., using a trained model to generate captions or textual description for a given input image).

One popular approach to multi-modal machine learning is the use of multi-modal language models, wherein an extra modality (e.g., image or video) is jointly used as training data and learned along with the use of natural language data (typically text data) as training data. Some of the most recent multi-modal language models include ViLBERT (trained using image and text data), VideoBERT (trained using video and text data), and CodeBERT (trained using software code and text data).

Outside of the field of multi-modal machine learning, some efforts have been made to build tools to assist in the design of artificial neural networks. Some of these tools leverage machine learning techniques to select an architecture for an artificial neural network that would be well suited to perform a specific inference task on a specific dataset. In particular, the field of neural architecture search (NAS) seeks to automate parts of the design process for artificial neural networks by processing an input dataset and identifying a neural network architecture (NA) that is likely to perform a given inference task on the dataset effectively after being trained.

However, NAS exhibits a number of limitations. Existing NAS approaches are limited to the selection of NAs for performing classification tasks (as opposed to other inference task types) on image data (as opposed to other modalities). NAS requires a dataset to be used as input, and its performance is limited to that specific dataset. NAS is extremely computationally complex, because it needs to be re-trained for each individual dataset and classification task. Furthermore, NAS can only perform a single function, namely the identification of a suitable NA for a given classification task on a given image dataset; the understanding of the trained model used for NAS cannot be leveraged to perform other useful related tasks.

The design of artificial neural networks is an extremely complex and important topic in the field of machine learning. Artificial neural networks are computational structures used for predictive modelling. A neural network typically includes multiple layers of neurons, each neuron receiving inputs from a previous layer, applying a set of weights to the inputs, and combining these weighted inputs to generate an output, which is in turn provided as input to one or more neurons of a subsequent layer. The output of a neural network is typically an inference performed with respect to the input data. An example of an inference task is classification, in which an input data sample is inferred to belong to one of a plurality of classes or categories.

A neural network is typically defined by its network architecture (NA), and by a current state of the learnable parameters (i.e., weights) of the network that define its behavior at a given stage of its training. The NA is typically defined by a graph and a set of hyperparameters (as distinct from the learnable parameters). The graph contains nodes corresponding to the neurons, and edges corresponding to the connections between the neurons. The hyperparameters define any behaviors or characteristics of the network other than its graph structure and weight values: for example, hyperparameters may define the operation of a training procedure when the network is in a training mode, as well as operation of an inference procedure when the network is in an inference mode.

Thus, there exists a need for a technique for understanding artificial neural network architectures, and for leveraging that understanding to perform useful tasks, that overcomes one or more of the shortcomings of the existing approaches described above.

### SUMMARY

In various examples, the present disclosure describes methods, systems, and computer-readable media for bi-modal understanding of natural language (NL) and artificial neural network architectures. A model trained in bi-modal understanding of NL and NA can be deployed to perform a number of useful tasks to assist with understanding, comparing, and identifying neural network architectures.

Some embodiments described herein may thereby solve one or more technical problems. Methods and systems are provided for joint learning of NL and NA and their relations. Example embodiments may provide NA search and retrieval based on NL inputs (e.g., textual description). Example embodiments may process NL to perform reasoning relating to NA, by determining whether a NL statement regarding a given NA is correct or not. Example embodiments may provide architectural question answering, by providing a NL answer to a NL question with respect to a given NA. Example embodiments may provide architecture clone detection, by checking whether two or more given NAs are semantically similar. Example embodiments may provide bi-modal architecture clone detection, by checking whether two or more given NAs are semantically similar based on a NL textual description—for example, NL providing criteria for a similarity check. Example embodiments may provide clone architecture search, by searching for and finding NAs that are semantically similar to a given NA. Example embodiments may provide bi-modal clone architecture search, by searching for and finding NAs that are semantically similar to a given NA that is supplemented by a supporting NL textual description. It will be appreciated that a model trained with a bi-modal understanding of NL and NA may be deployed to solve additional technical problems related to the relationship between natural language and neural network architectures, and that the methods and systems described herein may overcome additional technical problems related to the design and training of such a model.

Thus, various embodiments and examples described herein may provide:
A system that is capable of joint learning of NAs and NLs for inference tasks, and is therefore applicable to different NL and NA inference tasks.
A system that is capable of resolving the seven related inference tasks described above and in reference to FIGS. 4A-10 below.
A system that is dataset independent, in that no specific input dataset is required for performing the learning or inference tasks.
A system that is datatype agnostic, in that it can support learning and inference related to neural network architectures designed for learning any type of data (image, video, audio, text, etc.).
A system that is low complexity, in that it can perform retrieval tasks in a single inference, resulting in fast NL and NA retrieval and search services.
A system that can perform time- and cost-efficient inference in response to a simple natural language query, with the potential to significantly improve usability, user engagement, user exploration, and user experience, especially for beginner and intermediate users and developers in the field of machine learning.
A system that can be easily trained to support all natural languages, such as English, Chinese, French, etc., potentially making the system's services accessible in different languages and different countries.
A system that can output trainable and usable neural network architectures, which can be used directly by different types of users (including beginners) for performing machine learning tasks.

As used herein, the term “model” may refer to a mathematical or computational model. A model may be said to be implemented, embodied, run, or executed by an algorithm, computer program, or computational structure or device. In the present example embodiments, unless otherwise specified a model refers to a “machine learning model”, i.e., a predictive model intended to model human understanding of input such as language, implemented by an algorithm trained using deep learning or other machine learning techniques, such as a deep neural network (DNN).

As used herein, the term “neural network” may refer to an artificial neural network, which is a computational structure used to implement a model. A neural network is defined by a “network architecture” (NA), which typically includes a graph structure consisting of nodes (i.e. neurons) and edges (i.e. connections between neurons) as well as a set of hyperparameters defining the operation of the neural network during training and/or during performance of an inference task for which the neural network has been trained. The terms network, neural network, artificial neural network, and network may be used interchangeably herein unless indicated otherwise. The terms “artificial neural network architecture”, “neural network architecture”, “network architecture”, and “architecture” are used interchangeably herein unless indicated otherwise.

As used herein, the term “machine learning” (ML) may refer to a type of artificial intelligence that makes it possible for software programs to become more accurate at making predictions without explicitly programming them to do so.

As used herein, the term “image classification” may refer to categorizing and/or labeling images.

An “input sample” may refer to any data sample used as an input to a neural network, such as image data. It may refer to a training data sample used to train a neural network, or to a data sample provided to a trained neural network which will infer (i.e. predict) an output based on the data sample for the task for which the neural network has been trained. Thus, for a neural network that performs a task of image classification, an input sample may be a single digital image.

As used herein, the term “transformer” may refer to a machine learning model that adopts the mechanism of self-attention and weights each part of the input data differentially. Computer vision and natural language processing are the two areas in which transformers are most widely used.

As used herein, the term “BERT” is an acronym for Bidirectional Encoder Representations from Transformers. BERT is a deep learning model based on transformers, wherein every output element is related to every input element and weightings between the elements are dynamically calculated based on their connection.

As used herein, the term “encoder” may refer to a functional module for performing a process, encoding, by which a set of data is converted to a specialized format for efficient transmission or storage. In neural networks, encoders represent generic models that are able to generate a specific type of representation from input data.

As used herein, the term “embedder” may refer to a functional module for performing a process, embedding, used to simplify machine learning for large inputs. An example of embedding is generating sparse vectors representing words.

As used herein, the term “computational graph” (or simply “graph” if not otherwise specified) may refer to a directed graph in which the nodes represent mathematical operations. In mathematics, computational graphs can be used to express and evaluate neural network architectures and machine learning models.

As used herein, the term “directed acyclic graph” may refer to a graph whose edges are connected without cycles. This means that starting at one edge, there is no way to traverse the entire graph.

As used herein, the term “binary adjacency matrix” may refer to a graph represented by an adjacency matrix as a set of Boolean values (O's and l's), wherein the Boolean values of the matrix indicate whether there is a direct path between any two nodes.

As used herein, the terms “graph attention network” or “GAT” may refer to a neural network architecture that is designed to work with graph-structured data, such as graph convolutions, but leverages self-attentional masking layers to improve performance.

As used herein, the term “fully-connected layer” may refer to those layers within a neural network wherein each activation unit of one layer is connected to every activation unit of a subsequent layer.

As used herein, the term “convolution” may refer to the process of applying a filter of a convolutional neural network layer to an input to produce an activation. When the same filter is applied to an input several times, a feature map may be created, displaying the positions and intensity of a recognized feature in an input, such as an image.

As used herein, the term “pooling” may refer to a technique used in convolutional neural networks to enable the network to recognize features regardless of their location in the input by generalizing information retrieved by convolutional filters.

As used herein, the term “cosine similarity” may refer to a measure of the similarity of two vectors in an inner product space. Cosine similarity determines whether two vectors are pointing in the same general direction by measuring the cosine of the angle between them. In text analysis and other natural language processing (NLP) contexts, cosine similarity is frequently used to determine the degree of similarity of two language samples (e.g., two documents).

As used herein, the term “semantic search” may refer to a data searching strategy in which a search query seeks to discover a set of keywords a person is searching for, relying in part on the intent and contextual meaning of the keywords.

As used herein, the term “database” may refer to a logically ordered collection of structured data kept electronically in a computer system.

As used herein, the term “training” may refer to a procedure in which an algorithm uses historical data to extract patterns from them and learn to distinguish those patterns in as yet unseen data. Machine learning uses training to generate a trained model capable of performing a specific inference task.

As used herein, the term “finetuning”, “fine-tuning”, or “fine tuning” may refer to making small adjustments to a process (e.g., small adjustment to the weight values of a neural network) in order to obtain an intended result or performance. In deep learning, the weights of a partially trained deep learning model are fine tuned to generate a fully trained deep learning model.

As used herein, the term “similarity” may refer to semantic similarity, as evaluated by a model trained with a bi-modal understanding of natural language and neural network architectures. By using semantic similarity to evaluate architectural information, natural language information, or a mix of architectures and natural language information, embodiments described herein may exhibit greater accuracy in the analysis of those features of a neural network that are salient to human language and linguistic reasoning and characterization, thereby potentially capturing and focusing on details that are important to human users and their goals.

As used herein, a statement that an element is “for” a particular purpose may mean that the element performs a certain function or is configured to carry out one or more particular steps or operations, as described herein.

As used herein, statements that a second element is “based on” a first element may mean that characteristics of the second element are affected or determined at least in part by characteristics of the first element. The first element may be considered an input to an operation or calculation, or a series of operations or computations, which produces the second element as an output that is not independent from the first element.

In some aspects, the present disclosure describes a method comprising obtaining a model trained with a bi-modal understanding of natural language in relation to neural network architectures, providing input information to the model, and using the model to process the input information to generate inference information. The input information comprises at least one of the following: natural language information, and neural network architecture information.

In some aspects, the present disclosure describes a non-transitory computer-readable medium having instructions tangibly stored thereon that, when executed by a processing system, cause the processing system to obtain a model trained with a bi-modal understanding of natural language in relation to neural network architectures, providing input information to the model, and use the model to process the input information to generate inference information. The input information comprises at least one of the following: natural language information, and neural network architecture information.

In some aspects, the present disclosure describes a method. Input information is obtained, comprising at least one of the following: natural language information and neural network architecture information. The input information is transmitted to a system comprising a model trained with a bi-modal understanding of natural language in relation to neural network architectures. Inference information generated by the model by processing the input information is received.

In some examples, the model comprises a text encoder to process natural language information to generate word embeddings, a neural network architecture encoder to process neural network architecture information to generate graph encodings, a cross transformer encoder to process word embeddings and graph encodings to generate joint embeddings, a pooling module to pool the joint embeddings to generate encoded representations comprising fixed-size one-dimensional (1D) representations, and a similarity evaluator for processing encoded representations to determine a similarity measure using a cosine similarity metric.

In some examples, the text encoder comprises a tokenizer to process natural language information to generate a sequence of tokens, and a word embedder to process the sequence of tokens to generate word embeddings.

In some examples, the neural network architecture encoder comprises a graph generator to process neural network architecture information to generate a graph comprising a plurality of nodes, a plurality of edges, and a plurality of shapes, a shape embedder to process the plurality of shapes to generate shape embeddings, a node embedder to process the plurality of nodes to generate node embeddings, a summation module to sum the shape embeddings and node embeddings to generate a shape-node summation, and a graph attention network (GAT) for processing the summation and the plurality of edges to generate a graph encoding.

In some examples, obtaining the model comprises a number of steps. A training dataset is obtained, comprising a plurality of positive training samples, each positive training data sample comprising neural network architecture information associated with natural language information descriptive of the neural network architecture information, and a plurality of negative training samples, each negative training data sample comprising neural network architecture information associated with natural language information not descriptive of the neural network architecture information. The model is trained, using supervised learning, to maximize a similarity measure generated between the neural network architecture information and the natural language information of the positive training samples, and minimize the similarity measure generated between the neural network architecture information and the natural language information of the negative training samples.

In some examples, the method further comprises generating a neural network architecture database. For each of a plurality of neural network architecture information data samples the neural network architecture information data sample is processed, using the model, to generate an encoded representation of the neural network architecture information data sample. The neural network architecture information data sample is stored in the neural network architecture database in association with the encoded representation of the neural network architecture information data sample.

In some examples, the input information comprises natural language information comprising a textual description of a first neural network architecture, and the inference information comprises neural network architecture information corresponding to a neural network architecture similar to the first neural network architecture.

In some examples, using the model to process the input information to generate the inference information comprises a number of steps. The input information is processed, using the model, to generate an encoded representation of the input information. For each of a plurality of the encoded representations of the neural network architecture information data samples of the neural network architecture database, the model is used to generate a similarity measure between the encoded representations of the neural network architecture information data sample, and the input information. A neural network architecture information data sample associated with an encoded representation having a high value of the similarity measure is selected from the neural network architecture database. The inference information is generated based on the selected neural network architecture information data sample.

In some examples, the input information comprises natural language information comprising a textual description, and neural network architecture information corresponding to a first neural network architecture. The inference information comprises Boolean information indicating whether the textual description is descriptive of the first neural network architecture.

In some examples, using the model to process the input information to generate the inference information comprises processing the natural language information, using the model, to generate an encoded representation of the natural language information; processing the neural network architecture information, using the model, to generate an encoded representation of the neural network architecture information; using the model to generate a similarity measure between the encoded representations of the neural network architecture information and the natural language information; and generating the inference information based on the similarity measure.

In some examples, the method further comprises generating an answer database. For each of a plurality of answer data samples, each answer data sample comprising natural language information: the answer data sample is processed, using the model, to generate an encoded representation of the answer data sample. The answer data sample is stored in the neural network architecture database in association with the encoded representation of the answer data sample.

In some examples, the input information comprises natural language information comprising a question, and neural network architecture information corresponding to a first neural network architecture. The inference information comprises an answer data sample selected from the answer database, the selected answer data sample being responsive to the question.

In some examples, using the model to process the input information to generate the inference information comprises processing the neural network architecture information and natural language information, using the model, to generate a joint encoded representation of the neural network architecture information and natural language information; for each of a plurality of the encoded representations of the answer data samples of the answer database, using the model to generate a similarity measure between the encoded representation of the answer data sample and the joint encoded representation of the neural network architecture information and natural language information; selecting from the answer database an answer data sample associated with an encoded representation having a high value of the similarity measure; and generating the inference information based on the selected answer data sample.

In some examples, the input information comprises a first neural network architecture information data sample corresponding to a first neural network architecture, and a second neural network architecture information data sample corresponding to a second neural network architecture. The inference information comprises similarity information indicating a degree of semantic similarity between the first neural network architecture and the second neural network architecture.

In some examples, using the model to process the input information to generate the inference information comprises processing the first neural network architecture information data sample, using the model, to generate an encoded representation of the first neural network architecture information data sample; processing the second neural network architecture information data sample, using the model, to generate an encoded representation of the second neural network architecture information data sample; using the model to generate a similarity measure between the encoded representations of the first neural network architecture information data sample and the second neural network architecture information data sample; and generating the inference information based on the similarity measure.

In some examples, the input information further comprises natural language information comprising a textual description. Using the model to process the input information to generate the inference information further comprises processing the natural language information, using the model, to generate an encoded representation of the natural language information. The similarity measure is generated based on a similarity among the encoded representations of the first neural network architecture information data sample, the second neural network architecture information data sample, and the natural language information. The inference information indicates whether the first neural network architecture and the second neural network architecture are semantically similar in relation to the textual description.

In some examples, the input information comprises neural network architecture information corresponding to a first neural network architecture, and the inference information comprises neural network architecture information corresponding to a neural network architecture semantically similar to the first neural network architecture.

In some examples, the input information comprises neural network architecture information corresponding to a first neural network architecture, and natural language architecture information comprising a textual description. The inference information comprises neural network architecture information corresponding to a neural network architecture semantically similar to the first neural network architecture in relation to the textual description.

In some aspects, the present disclosure describes a non-transitory computer-readable medium having instructions tangibly stored thereon, wherein the instructions, when executed by a processor device of a computing system, cause the computing system to perform one or more of the methods described above.

### BRIEF DESCRIPTION OF THE DRAWINGS

Reference will now be made, by way of example, to the accompanying drawings which show example embodiments of the present application, and in which:

FIG. 1 is a block diagram of an example computing system that may be used to implement examples described herein.

FIG. 2 is a schematic diagram of an example architecture for a machine learning model trained with bi-modal understanding of natural language and network architectures, in accordance with the present disclosure.

FIG. 3 is a flowchart showing operations of a method for training the bi-modal model of FIG. 2 in a training mode, followed by operation of the bi-modal model in an inference mode to perform various inference tasks, in accordance with the present disclosure.

FIG. 4A is a block diagram showing operations of the bi-modal model of FIG. 2 to generate a NA database, in accordance with the present disclosure.

FIG. 4B is a block diagram showing operations of the bi-modal model of FIG. 2 to perform an architectural search and retrieval task, in accordance with the present disclosure.

FIG. 5 is a block diagram showing operations of the bi-modal model of FIG. 2 to perform an architectural reasoning task, in accordance with the present disclosure.

FIG. 6A is a block diagram showing operations of the bi-modal model of FIG. 2 to generate an answer database, in accordance with the present disclosure.

FIG. 6B is a block diagram showing operations of the bi-modal model of FIG. 2 to perform an architectural question answering task, in accordance with the present disclosure.

FIG. 7 is a block diagram showing operations of the bi-modal model of FIG. 2 to perform an architectural clone detection task, in accordance with the present disclosure.

FIG. 8 is a block diagram showing operations of the bi-modal model of FIG. 2 to perform a bi-modal architectural clone detection task, in accordance with the present disclosure.

FIG. 9 is a block diagram showing operations of the bi-modal model of FIG. 2 to perform an architectural clone search task, in accordance with the present disclosure.

FIG. 10 is a block diagram showing operations of the bi-modal model of FIG. 2 to perform a bi-modal architectural clone search task, in accordance with the present disclosure.

Similar reference numerals may have been used in different figures to denote similar components.

### DESCRIPTION OF EXAMPLE EMBODIMENTS

Methods, systems, and computer-readable media for bi-modal understanding of natural language (NL) and artificial neural network architectures (NA) will now be described with reference to example embodiments. In some examples, a model and method of training the model for bi-modal understanding of NL and NA are described. In some examples, a model trained in bi-modal understanding of NL and NA can be deployed to perform tasks such as processing NL to perform reasoning relating to NA, architectural question answering, architecture clone detection, bi-modal architecture clone detection, clone architecture search, and/or bi-modal clone architecture search.

Example embodiments may be described herein with reference to an example implementation framework entitled “ArchBERT”. ArchBERT may encompass a number of techniques for generating and deploying a model trained with bi-modal understanding of NL and NA.

Example Computing System

A system or device, such as a computing system, that may be used in examples disclosed herein is first described.

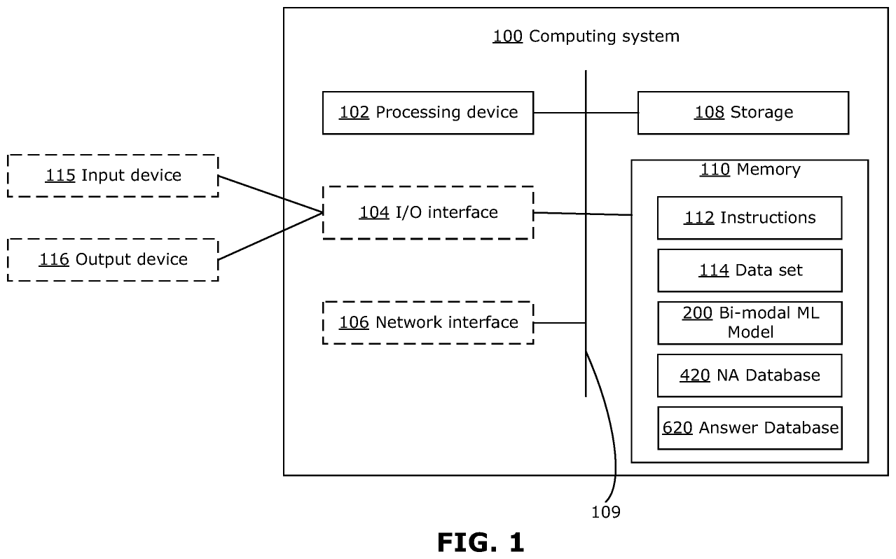

FIG. 1 is a block diagram of an example simplified computing system 100, which may be a device that is used to execute instructions 112 in accordance with examples disclosed herein, including the instructions of a bi-modal machine learning model 200 trained to learn a bi-modal understanding of natural language (NL) and artificial neural network architectures (NA). Other computing systems suitable for implementing embodiments described in the present disclosure may be used, which may include components different from those discussed below. In some examples, the computing system 100 may be implemented across more than one physical hardware unit, such as in a parallel computing, distributed computing, virtual server, or cloud computing configuration. Although FIG. 1 shows a single instance of each component, there may be multiple instances of each component in the computing system 100.

The computing system 100 may include a processing system having one or more processing devices 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing system 100 may also include one or more optional input/output (I/O) interfaces 104, which may enable interfacing with one or more optional input devices 115 and/or optional output devices 116. In the example shown, the input device(s) 115 (e.g., a keyboard, a mouse, a microphone, a touchscreen, and/or a keypad) and output device(s) 116 (e.g., a display, a speaker and/or a printer) are shown as optional and external to the computing system 100. In other examples, one or more of the input device(s) 115 and/or the output device(s) 116 may be included as a component of the computing system 100. In other examples, there may not be any input device(s) 115 and output device(s) 116, in which case the I/O interface(s) 104 may not be needed.

The computing system 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The computing system 100 may also include one or more storage units 108, which may include a mass storage unit such as a solid state drive, a hard disk drive, a magnetic disk drive and/or an optical disk drive. The computing system 100 may include one or more memories (collectively memory 110), which may include a volatile or non-volatile memory (e.g., a flash memory, a random access memory (RAM), and/or a read-only memory (ROM)). The non-transitory memory 110 may store instructions 112 for execution by the processing device(s) 102, such as to carry out examples described in the present disclosure. The memory 110 may include other software instructions 112, such as for implementing an operating system and other applications/functions. In some examples, memory 110 may include software instructions 112 for execution by the processing device 102 to train a bi-modal machine learning model 200 and/or to implement a trained bi-modal machine learning model 200, as disclosed herein. The non-transitory memory 110 may store data, such as a data set 114 including multiple data samples. As described below, the data set 114 may include a training dataset used to train the bi-modal machine learning model 200, and/or data samples provided to the trained bi-modal machine learning model 200 for performing various inference tasks.

In some other examples, one or more data sets and/or modules may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 109 providing communication among components of the computing system 100, including the processing device(s) 102, I/O interface(s) 104, network interface(s) 106, storage unit(s) 108 and/or memory 110. The bus 109 may be any suitable bus architecture including, for example, a memory bus, a peripheral bus or a video bus. In some examples, the computing system 100 is a distributed computing system and the functions of the bus 109 may be performed by the network interfaces 106 in communication with communication links.

Example Bi-Modal NL+NA Understanding Model

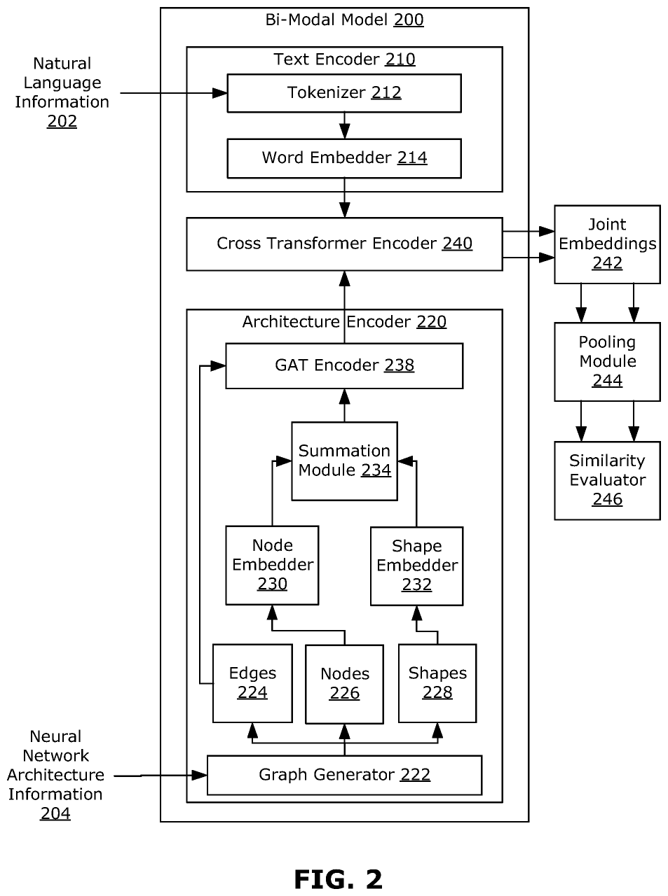

FIG. 2 illustrates an example architecture of a machine learning model trained with a bi-modal understanding of NL and NA, shown as bi-modal model 200. The illustrated bi-modal model 200 corresponds to the ArchBERT architecture. The bi-modal model 200 can be implemented, in various embodiments, as software instructions, hardware logic, or some combination thereof. In some examples, the bi-modal model 200 is implemented as software instructions tangibly stored on a non-transitory computer-readable medium, as described above with reference to the computing system 100 of FIG. 1. When executed by the processor device(s) 102 of the processing system, the instructions cause the processing system to perform the functions of the bi-modal model 200 as described herein.

The bi-modal model 200 includes a text encoder 210 to process natural language information to generate word embeddings, a neural network architecture encoder 220 to process neural network architecture information to generate graph encodings, a cross transformer encoder 240 to process word embeddings and graph encodings to generate joint embeddings 242, a pooling module 244 to pool the joint embeddings to generate encoded representations comprising fixed-size one-dimensional (1D) representations, and a similarity evaluator 246 for processing encoded representations to determine a similarity measure using a cosine similarity metric.

The text encoder 210 includes a tokenizer 212 to process natural language information 202 to generate a sequence of tokens, and a word embedder 214 to process the sequence of tokens to generate word embeddings. Natural language information 202, such as a textual description, is fed to the text encoder 210 to encode and map the natural language information 202 to word representations, such as word embeddings. To do this, the text encoder 210 uses the tokenizer 212 to tokenize and split all the words in the natural language information 202. The sequence of words (i.e. tokens) is then provided to the word embedder 214 to compute the corresponding word embeddings (i.e. word representations). As used herein, a “word embedding” may refer to a real-valued vector that encodes the meaning of a word such that words that are close together in the vector space are expected to be similar in meaning.

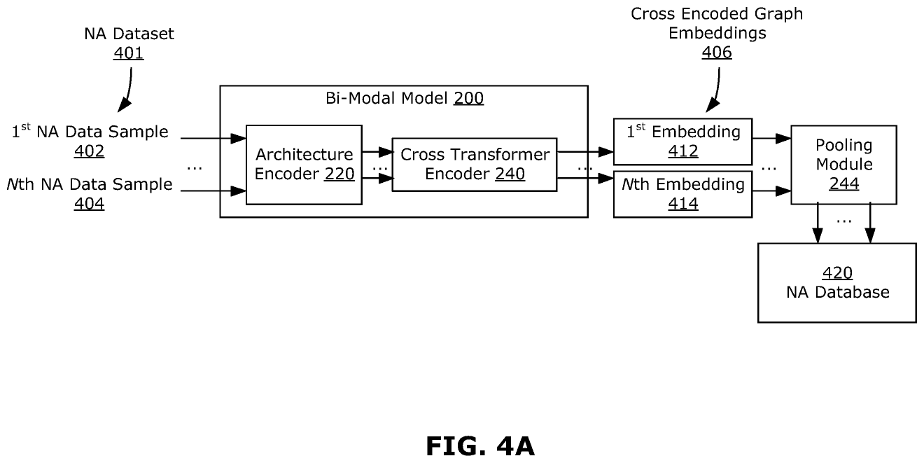

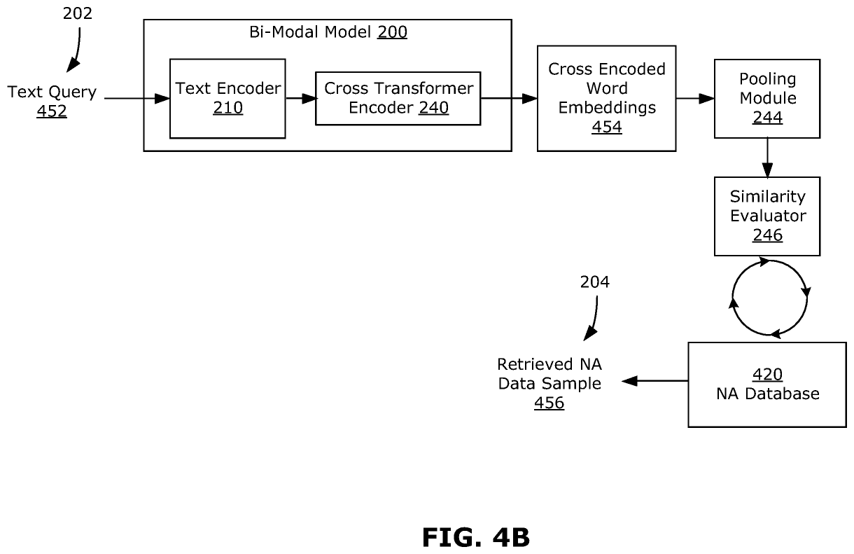

In some embodiments, a single natural language information 202 input (i.e., a single natural language information 202 data sample) includes textual information, such as a sequence of text characters. In some examples, the natural language information 202 data sample is a textual description of a neural network architecture, a textual question, a textual answer to a question, or another form of textual information, as described in greater detail below with reference to FIGS. 4A-10.

The neural network architecture encoder 220 includes several functional modules. A graph generator 222 is used to process neural network architecture information 204 to generate a graph comprising a plurality of nodes 226, a plurality of edges 224, and a plurality of shapes 228. A shape embedder 232 processes the plurality of shapes 228 to generate shape embeddings. A node embedder 230 processes the plurality of nodes 226 to generate node embeddings. A summation module 234 sums the shape embeddings and node embeddings to generate a shape-node summation. A graph attention network (GAT) processes the shape-node summation and the plurality of edges 224 to generate a graph encoding.

The architecture encoder 220 is thus responsible for encoding the neural network architecture information 204 inputs. In some embodiments, a single neural network architecture information 204 input (i.e., a single neural network architecture information 204 data sample) encodes a single architecture of an artificial neural network. The architecture may be encoded as a computational graph (representing the neurons, layers, and neuronal interconnections of the network) and a set of hyperparameters (representing details of the operation of the network during training and/or inference). In embodiments described herein, the values of the learnable parameters of the neural network need not be included in the neural network architecture information 204. Thus, in some examples, the data representing an entire artificial neural network may include both neural network architecture information 204 defining the network's architecture, as well as all current values of the learnable parameters. The vast majority of the data representing a neural network represents the current values of the learnable parameters; the amount of data required to represent the network's architecture is typically quite small in relative terms, usually by several orders of magnitude.

In operation, the computational graph of the neural network architecture information 204 is extracted by the graph generator 222 and represented with a directed acyclic graph wherein the nodes 226 are operations (e.g., convolutions, fully-connected layers, summations, etc.) and the connectivity of the nodes 226 is described by a binary adjacency matrix consisting of edges 224. In addition to the nodes 226 and edges 224, the graph generator 222 also extracts the shapes 228 of learnable parameters associated with the nodes 226.

The nodes 226 and shapes 228 are separately encoded by the node embedder 230 and shape embedder 232, respectively. The edges 224, along with the node-shape summation generated by the summation module 234, are then provided to the GAT encoder 238 to generate the final architecture embedding, represented as a graph embedding. The GAT encoder 238 uses a Graph Attention Network (GAT) to perform the final encoding.

In operation, the cross transformer encoder 240 processes the word embeddings and graph embeddings to generate joint embeddings 242. In some embodiments, a cross transformer encoder 240 similar to BERT models is employed. The cross transformer encoder 240 enables joint learning of NL (e.g., textual) and NA (i.e., architectural) embeddings, in this example represented as word embeddings and graph embeddings respectively, and sharing of learning signals between both modalities. The word and graph embeddings are processed simultaneously to create their corresponding joint embeddings 242. In some examples, the joint embeddings 242 include two types of cross encoded embeddings: word embeddings cross encoded with architecture information, and graph embeddings cross encoded with natural language information, such that both cross encoded embeddings are vectors of the same length. In some examples, the two types of cross encoded embeddings of the joint embeddings may be concatenated together to form the joint embedding. In some examples, a natural language information data sample containing N number of words results in the generation of N word embeddings, and a neural network architecture information data sample containing M nodes in its computation graph results in the generation of M graph embeddings. In some such examples, the joint embeddings 242 may include N word embeddings cross encoded with architecture information, and M graph embeddings cross encoded with natural language information. In order to enable concatenation in cases where N!=M, in some examples one set of embeddings or the other may be padded with zero-padding to equalize the sizes of the two sets of embeddings. These joint embeddings 242 are then pooled by the pooling module 244 to generate fixed-size one-dimensional (1D) representations. The similarities of the fixed-size 1D representations (i.e., the similarity of the fixed-size 1D NL representation to the fixed-size 1D NA representation) are then evaluated by the similarity evaluator 246, for example using a cosine similarity metric.

In some examples, a fixed 1D NL representation may consist of a single embedding for all the words in a text, and may be referred to as a “text embedding” or a “sentence embedding”.

Example Bi-Modal NL+NA Training and Inference Method

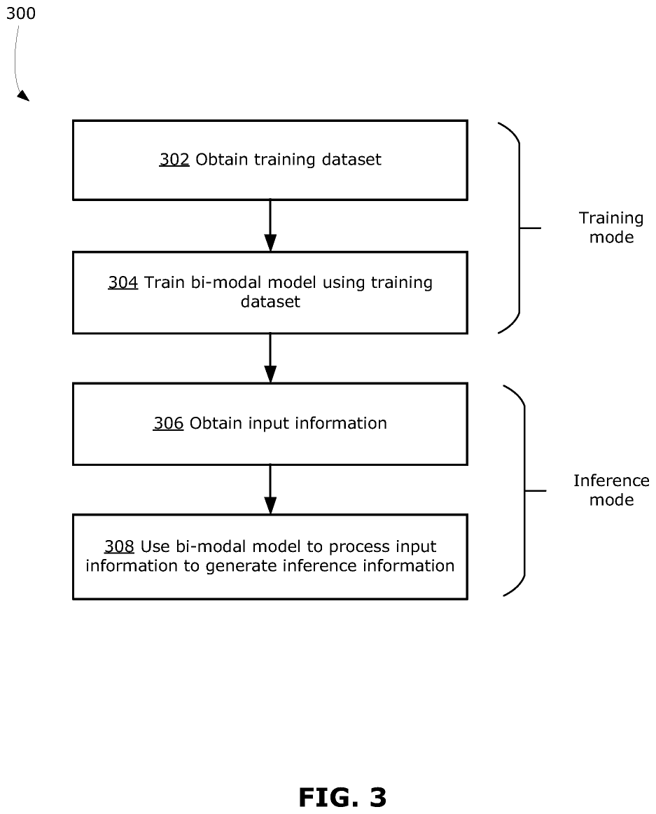

FIG. 3 illustrates a flowchart showing operations of a method 300 for training the bi-modal model 200 in a training mode, followed by operation of the bi-modal model 200 in an inference mode to perform various inference tasks. Examples of inference tasks that may be performed by the bi-modal model 200 are described below with reference to FIGS. 4A-10. Each of these inference tasks may be regarded as a special case of the inference task operations shown in FIG. 3.

Operations 302 and 304 constitute the training steps of method 300. In this example method 300, the bi-modal model 200 is trained using supervised learning. Operations 306 through 308 constitute the inference task steps of method 300.

In order train the bi-modal model 200, at 302 a training dataset is obtained. The training dataset includes both positive and negative training data samples. Each positive training data sample includes neural network architecture information 204 associated with natural language information 202 descriptive of the neural network architecture information. Thus, for example, a single positive training data sample may include a computational graph and hyperparameters corresponding to a convolutional neural network with four convolution blocks and two fully-connected layers (i.e. the neural network architecture information 204), labelled with a semantic label consisting of an accurate textual description (e.g., the text “A convolutional neural network with four convolution blocks and two fully-connected layers”) (the natural language information 202). An example negative training data sample may include a computational graph and hyperparameters corresponding to a recurrent neural network with six layers (i.e. the neural network architecture information 204), labelled with a semantic label consisting of inaccurate or mis-descriptive natural language information 202, i.e., text that does not describe the neural network architecture information 204. In some examples, the natural language information 202 may describe a different neural network architecture (e.g., the text “An efficient object detector with no residual layers”); in some examples, the natural language information 202 may describe something other than a neural network or may be other unrelated text.

At 304, the training dataset is used to train the bi-modal model 200 using supervised learning. The use of both positive and negative training data samples enables the bi-modal model 200 to learn both similarities and dissimilarities between NA and NL information. In other words, during the training procedure, the bi-modal model 200 learns to maximize the similarity measure (e.g., cosine similarity) generated between the neural network architecture information 204 and the natural language information 202 of the positive training samples, and to minimize the similarity measure generated between the neural network architecture information 204 and the natural language information 202 of the negative training samples. In some embodiments, a loss function may be computed based on the similarity measure and back-propagated through the bi-modal model 200 to adjust the values of the learnable parameters thereof, for example using gradient descent.

At 306, after the bi-modal model 200 has been trained, inference is performed by the trained bi-modal model 200, beginning with receiving input information to be used for performing the inference task. The input information includes at least one of the two types of information understood by the bi-modal: i.e., the input information contains natural language information 202, neural network architecture information 204, or both. In some examples, the input information includes more than one data sample of a given information type, as described in further detail in reference to FIGS. 4A-10 below.

At 308, the bi-modal model 200 is used to process the input information to generate inference information. In some examples, the inference information is, or is based on, the similarity measure generated by the similarity evaluator 246. Examples of different types of inference information and their relationship with the similarity measure are described below with reference to FIG. 4A-10.

In some examples, an end user may supply input information in order to obtain the inference information from the bi-modal model 200. For example, a user may make use of any of the inferential capabilities of the bi-modal model 200 (such as those described below with reference to FIG. 4A-10) by interacting with the bi-modal model 200, either on the same computing system 100 implementing the bi-modal model 200, or on a remote system in communication with the computing system 100 via the network interface 106.

To use the bi-modal model 200 for performing inference on input data, the user operates a user device (such as a mobile computing device or a desktop computer) to transmit the input information to a system (such as computing system 100) comprising a model trained with a bi-modal understanding of natural language in relation to neural network architectures (such as the bi-modal model 200). The transmitted input information may be received by computing system 100 via network interface 106. As described above, the input information includes at least one of the two types of information understood by the bi-modal: i.e., the input information contains natural language information 202, neural network architecture information 204, or both. The user device then receives the inference information generated by the bi-modal model 200 by processing the input information.

In the following sections of this description, various examples are described by which the trained bi-modal model 200 may be applied to perform various inference tasks.

Example of Architectural Search and Retrieval Using NL

FIG. 4A is a block diagram showing operation of the bi-modal model 200 to generate a NA database 420. The NA database 420 generated by these operations may be used to perform various further inference tasks, as described in greater detail below with reference to the examples of FIGS. 4B, 9, and 10.

Any semantic search engine typically requires a database to act as a knowledge base of all indexed data and embeddings thereof (e.g., cross encoded word embeddings or cross encoded graph embeddings). The semantic search engine searches within this database. The operations of FIG. 4A illustrate how the bi-modal model 200 can be used to generate a NA database 420 that can be used to perform semantic searches relating to neural network architecture information. The NA database 420 stores cross encoded graph embeddings in association with their respective neural network architecture information.

To generate the NA database 420, a NA dataset 401 of neural network architecture information 204 is processed by the trained bi-modal model 200. Each data sample of the NA dataset 401, from a first NA data sample 402 through a final Nth NA data sample 404, is processed by the architecture encoder 220 to generate a respective set of graph embeddings. Each set of graph embeddings is then cross-encoded by the trained cross transformer encoder 240 to generate a respective set of cross encoded graph embeddings 406, from a first set of cross encoded graph embeddings 412 to a final Nth set of cross encoded graph embeddings 414. Each of these sets of embeddings 406 is pooled by the pooling module 244, and the resulting fixed-size 1D representation is stored in the NA database 420 in association with its respective input data, i.e., the corresponding NA data sample from the NA dataset 401. Thus, the generated NA database 420 contains, for each NA data sample 402 through 404 of the NA dataset 401, an encoded representation of the NA data sample (i.e. the fixed-size 1D representation as encoded by the trained bi-modal model 200) along with, or associated with, the NA data sample itself. Like other search engines, some embodiments may index the NA database 420 to speed up search operations.

FIG. 4B is a block diagram showing operation of the bi-modal model 200 to perform an architectural search and retrieval task, using the NA database 420.

The trained bi-modal model 200 is used to process a search query and perform the search over the NA database 420. The input information is a text query 202, which is natural language information 202 that includes a textual description of a given neural network architecture, referred to herein as the “first neural network architecture” (e.g., “An efficient object detector with no residual layers”). The text query 202 is first encoded using the text encoder 210. The text encodings (i.e. the word embeddings) are then cross-encoded by the cross transformer encoder 240 to ensure that the previously-learned architectural knowledge is also utilized for computing final cross-encoded word embeddings 454. The pooled representations generated by the pooling module 244 are then processed by the similarity evaluator 246: the pooled representation (i.e. the fixed-size 1D representation of the text query 452) is compared to each of the encoded representations stored in the NA database 420 to find and return one or more closely-matching (i.e., having a high value for the similarity measure) NA data samples as the inference information. For example, in response to the text query 452 specified above (“An efficient object detector with no residual layers”), the bi-modal model 200 may return a copy of an NA data sample stored in the NA database 420 corresponding to a FastRCNN architecture accurately described by the text query 452.

The inference information is shown in FIG. 4B as a single retrieved NA data sample 456 retrieved from the NA database 420; however, it will be appreciated that in some examples the one or more similar retrieved NA data samples may be included, either in their original format or individually and/or jointly post-processed into another format, in the information returned to a user or querying process. Thus, the inference information includes neural network architecture information 204 corresponding to at least one neural network architecture similar to the first neural network architecture described by the text query 452. The inference information is generated based on at least one neural network architecture information data sample 456 retrieved or selected from the NA database 420 on the basis of the similarity measure.

Thus, a user or querying process may use the NA search operation described above to retrieve one or more example network architectures that match a textual description. In some examples, this may allow users to view one or more neural network architectures that may be suitable for a described task or application. In some examples, this may allow users to quickly learn or recall which architectures correspond to certain linguistically described features.

Example of NL for Architectural Reasoning

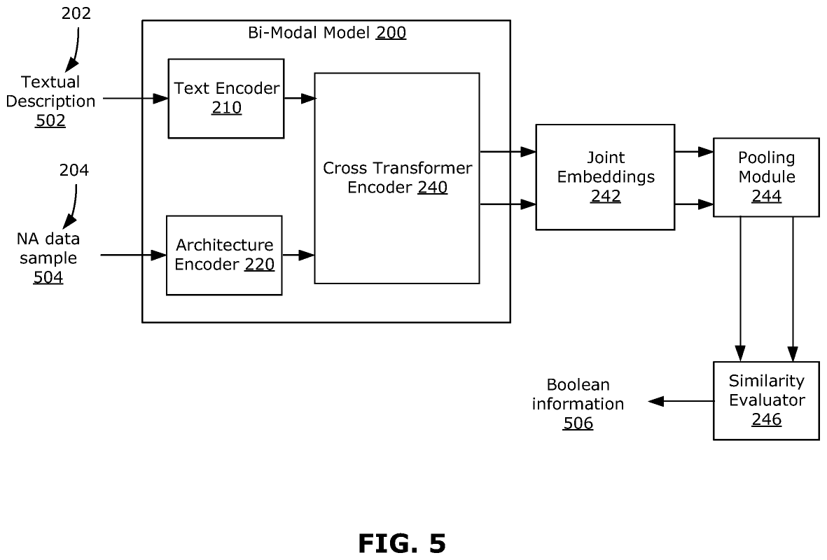

FIG. 5 is a block diagram showing operation of the bi-modal model 200 to perform an architectural reasoning task. The input information includes both a textual description 502 (i.e. natural language data 202) and a NA data sample 504 corresponding to a first neural network architecture (i.e. neural network architecture information 204). These inputs are processed by the text encoder 210 and architecture encoder 220, respectively, of the trained bi-modal model 200, and are then cross-encoded by the cross transformer encoder 240 to generate joint embeddings 242. The joint embeddings 242 are pooled by the pooling module 244 to generate encoded representations (i.e. fixed-size 1D representations) of the inputs, and the similarity evaluator 246 generates a value for the similarity measure between the textual description 502 and the NA data sample 504. Based on the value of the similarity measure, an output is generated that includes Boolean information 506 indicating similarity or lack of similarity: for example, values of the similarity measure above a similarity threshold (e.g., a threshold T=0.8 for similarity measure values ranging from 0 to 1) may result in a positive Boolean output (e.g. “True” or “Correct”), whereas similarity measure below the similarity threshold may result in a negative Boolean output (e.g. “False” or “Incorrect”).

Thus, the bi-modal model 200 can be used to generate inference information indicating whether the textual description 502 is descriptive of the first neural network architecture. A user or querying process may use the NA reasoning operation described above to determine whether a given neural network architecture matches a textual description or a linguistic proposition. In some examples, this may allow users to determine whether a given neural network architecture is suitable for a described task or application. In some examples, this may allow users to quickly learn or recall which architectures correspond to certain linguistically described features.

Example of Architectural Question Answering

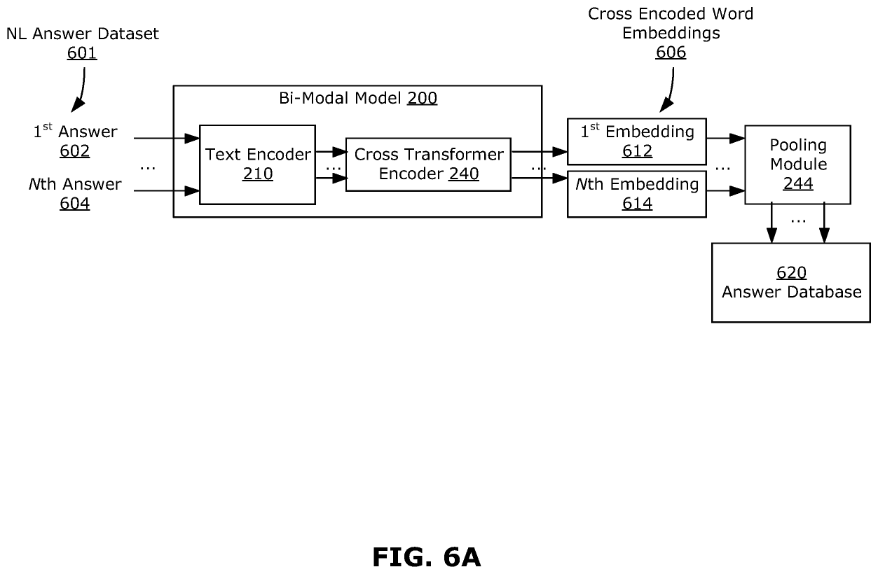

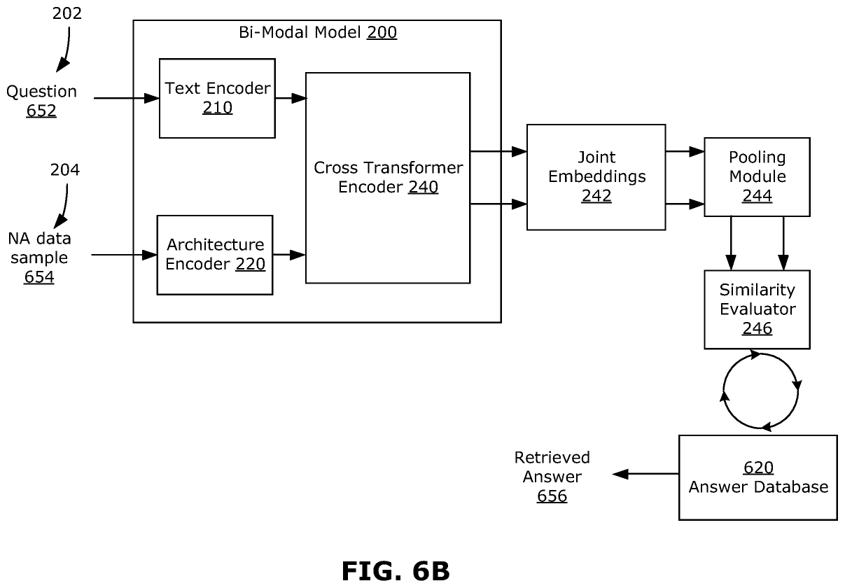

FIG. 6A is a block diagram showing operations of the bi-modal model 200 to generate an answer database 620. The answer database 620 can be used for semantic search, similarly to the NA database 420 described above with reference to FIG. 4A, and may be used to perform various further inference tasks, as described in greater detail below with reference to the example of FIG. 6B.

To generate the answer database 620, an answer dataset 601 of natural language information 202 is processed by the trained bi-modal model 200. The data samples of the answer dataset 601 are answers (i.e. answer data samples), in natural language (e.g., text), to questions. Each data sample of the answer dataset 601, from a first answer 602 through a final Nth answer 602, is processed by the text encoder 210 to generate a respective set of word embeddings. Each set of word embeddings is then cross-encoded by the trained cross transformer encoder 240 to generate a respective set of cross encoded word embeddings 606, from a first set of cross encoded word embeddings 612 to a final Nth set of cross encoded word embeddings 614. Each of these embeddings 606 is pooled by the pooling module 244, and the resulting fixed-size 1D representation is stored in the answer database 620 in association with its respective input data, i.e., the corresponding answer from the answer dataset 601. Thus, the generated answer database 620 contains, for each answer 602 through 604 of the answer dataset 601, an encoded representation of the answer (i.e. the fixed-size 1D representation as encoded by the trained bi-modal model 200) along with, or associated with, the answer itself (in natural language format). Like other search engines, some embodiments may index the answer database 620 to speed up search operations.

FIG. 6B is a block diagram showing operation of the bi-modal model 200 to perform an architectural question answering task. The inputs are a question 652 encoded as natural language information 202 (e.g. text) and a NA data sample 654 encoded as neural network architecture information 204 corresponding to a first neural network architecture. The inputs 652, 654 are first encoded by the trained bi-modal model 200 using the text encoder 210 and architecture encoder 220, respectively. Both embeddings are then cross-encoded by the cross transformer encoder 240 to ensure that the embeddings receive signals from each other in order to generate the final joint embeddings 242. The joint embeddings 242 are pooled by the pooling module 244, and the pooled embeddings (i.e. the fixed-size 1D cross-encoded representations of the question and the architecture) are then compared with each encoded representation stored in the answer database 620 to find and return one or more highly-similar answers 656 retrieved from the answer database 620 to the user or the querying process.

In some examples, a retrieved answer 656 is selected from the answer database 620 based on two values of the similarity measure: a first value of the similarity measure comparing the question encoding (i.e. the fixed-size 1D cross-encoded representation of the question 652) to the retrieved answer encoding, and a second value of the similarity measure comparing the architecture encoding (i.e. the fixed-size 1D cross-encoded representation of the NA data sample 654) to the retrieved answer encoding (i.e. the fixed-size 1D cross-encoded representation of an answer stored in the answer database in association with the retrieved answer 656). In some examples, the two similarity measure values may be combined to determine an overall similarity measure. In some embodiments, the combination of the two similarity measures is performed as an average. In other embodiments, the combination of the two similarity measures may be performed as a sum, a minimum, or a maximum of the two values, or by any other suitable means.

Thus, in some examples, the inference information generated by the question answer task therefore includes an answer 656, i.e. an answer data sample selected and retrieved from the answer database 620. The selected answer data sample 656 is responsive to the question 652. In some examples, the inference information is generated based on the retrieved answer 656, for example the output of post-processing performed on the retrieved answer 656.

In some embodiments, the bi-modal model 200 may be fine-tuned after initial training but before being deployed to perform a question answering task. Fine-tuning may be performed using an additional training dataset, which may include questions (NL information), architectures (NA information), and answers (NL information). This fine-tuning operation may improve bi-modal understanding of the relationships between questions and answers with respect to various neural network architectures.

Thus, the bi-modal model 200 can be used to generate inference information indicating an answer to a question about a given neural network architecture. In some examples, this may allow users to determine whether a given neural network architecture is suitable for a described task or application, whether a given neural network architecture exhibits certain features or characteristics, or to answer questions about the potential applications or characteristics of a given neural network architecture.

Example of Architectural Clone Detection

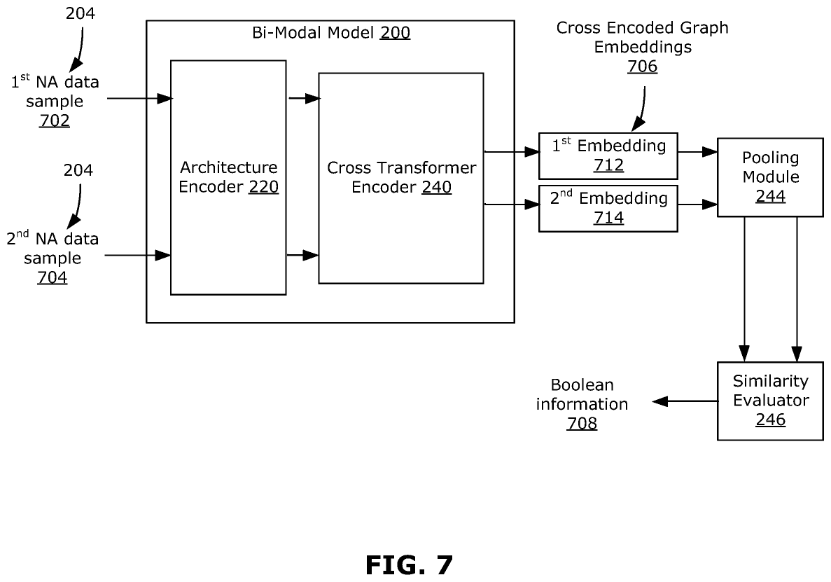

FIG. 7 is a block diagram showing operations of the bi-modal model 200 to perform an architectural clone detection task. The architectural clone detection task is similar in some respects to the architectural reasoning task described above with reference to FIG. 5; however, instead of comparing a textual description to an architecture to determine their semantic similarity, clone detection instead compares two architectures.

The input information includes a first neural network architecture information data sample 702 corresponding to a first neural network architecture, and a second neural network architecture information data sample 704 corresponding to a second neural network architecture, both encoded as neural network architecture information 204. These inputs are processed by the architecture encoder 220 of the trained bi-modal model 200, and are then each cross-encoded by the cross transformer encoder 240 to generate respective cross-encoded graph embeddings 706, namely first cross-encoded graph embedding 712 and second cross-encoded graph embedding 714. The cross-encoded graph embeddings 706 are each pooled by the pooling module 244 to generate encoded representations (i.e. fixed-size 1D representations) of the inputs, and the similarity evaluator 246 generates a value for the similarity measure between the first neural network architecture information data sample 702 and the second neural network architecture information data sample 704. Based on the value of the similarity measure, an output is generated that includes Boolean information 708 indicating a degree of semantic similarity or lack of semantic similarity: for example, values of the similarity measure above a similarity threshold (e.g., a threshold T=0.8 for similarity measure values ranging from 0 to 1) may result in a positive Boolean output (e.g. “Similar”), whereas similarity measure below the similarity threshold may result in a negative Boolean output (e.g. “Not Similar”).

Thus, the bi-modal model 200 can be used to generate inference information indicating whether a first neural network architecture is similar or dissimilar to a second neural network architecture. A user or querying process may use the clone detection operation described above to determine whether a first given neural network architecture is highly similar, in terms typically captured by human linguistic reasoning, to a second given neural network architecture. In some examples, this may allow users to determine whether a second neural network architecture can be substituted for a first neural network architecture to perform a task or application. In some examples, this may allow users to detect neural network architectures that have been copied with only minor, non-substantive changes.

Example of Bi-Modal Architectural Clone Detection

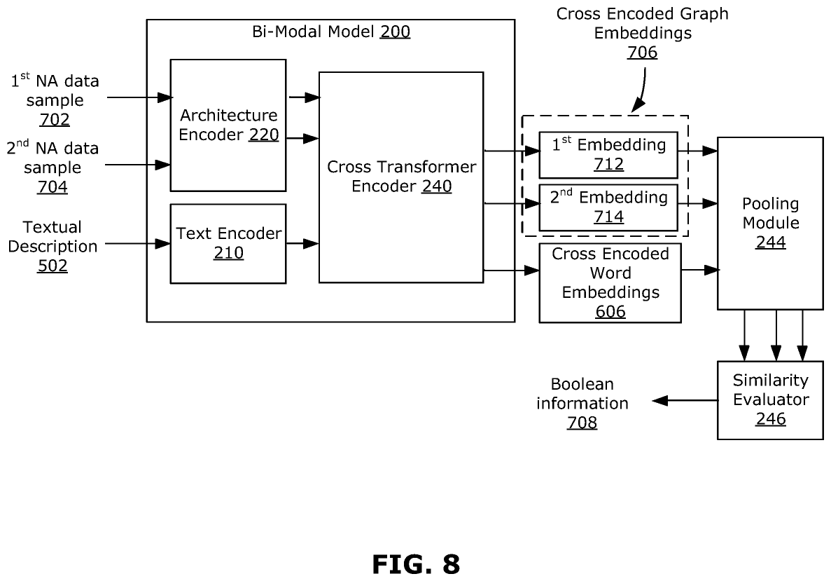

FIG. 8 is a block diagram showing operations of the bi-modal model 200 to perform a bi-modal architectural clone detection task. The bi-modal architectural clone detection task is similar to the architectural clone detection task described in the previous section, except that bi-modal architectural clone detection also uses as input a supporting textual description 502. The textual description 502 is also encoded, cross-encoded, and pooled along with the two input architecture data samples 702, 704. The similarity of the two architectures' embeddings, and the similarity of both architecture's embedding to the text embedding, is evaluated to determine whether the architectures are similar or not.

Thus, the input information further comprises natural language information comprising a textual description 502. The bi-modal model 200 processes the textual description 502 to generate an encoded representation of the natural textual description 502, i.e., fixed-size 1D cross-encoded representation of the textual description 502. The similarity measure is generated based on a similarity among the encoded representations of the first neural network architecture information data sample 702, the second neural network architecture information data sample 704, and the textual description 502.

In some examples, the inference information indicates whether the first neural network architecture and the second neural network architecture are semantically similar in relation to the textual description 502. For example, three similarity measures may be calculated and combined, indicating the respective similarities between each of the following pairs: the first neural network architecture and the second neural network architecture, the first neural network architecture and the textual description 502, and the second neural network architecture and the textual description 502. In other examples, the only similarity measures used to generate the inference information are between: the first neural network architecture and the second neural network architecture, and the second neural network architecture and the textual description 502 (i.e., it is assumed that the textual description 502 is descriptive of the first neural network architecture). This combination may be performed as an average or using any other suitable technique, as described above with reference to FIG. 6A.

Example of Clone Architecture Search

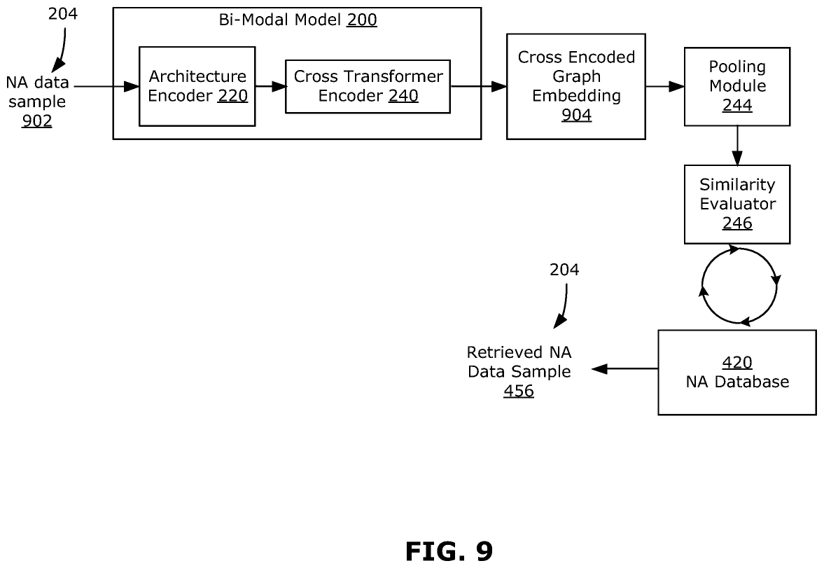

FIG. 9 is a block diagram showing operations of the bi-modal model 200 to perform an architectural clone search task. The architectural clone search task combines features of the architectural search task of FIG. 4B and the architectural clone detection task of FIG. 7.

In architectural clone search, the bi-modal model 200 is used to search and retrieve from the NA database 420 network architectures that are semantically similar to an architecture provided as input to the clone search operation. The input information is a single NA data sample 902. The NA data sample 902 is encoded, cross-encoded to generate the cross encoded graph embedding 904, and pooled to generate the final encoded representation (e.g., a fixed-size 1D cross encoded representation) as described above. The similarity evaluator 246 compares the final encoded representation to each of the encoded representations stored in the NA database 420. Highly similar encoded representations are selected (e.g., having T>0.8) and their associated NA data samples are returned as inference information based on or including one or more retrieved NA data samples 456, as in the search operation of FIG. 4B.

Thus, a user or querying process may use the architectural clone search operation described above to retrieve one or more example network architectures that match an existing first network architecture provided as input. In some examples, this may allow users to view one or more neural network architectures that may be suitable for the same tasks or applications as the known network architecture. In some examples, this may allow users to detect neural network architectures that have been copied with only minor, non-substantive changes.

Example of Bi-Modal Clone Architecture Search

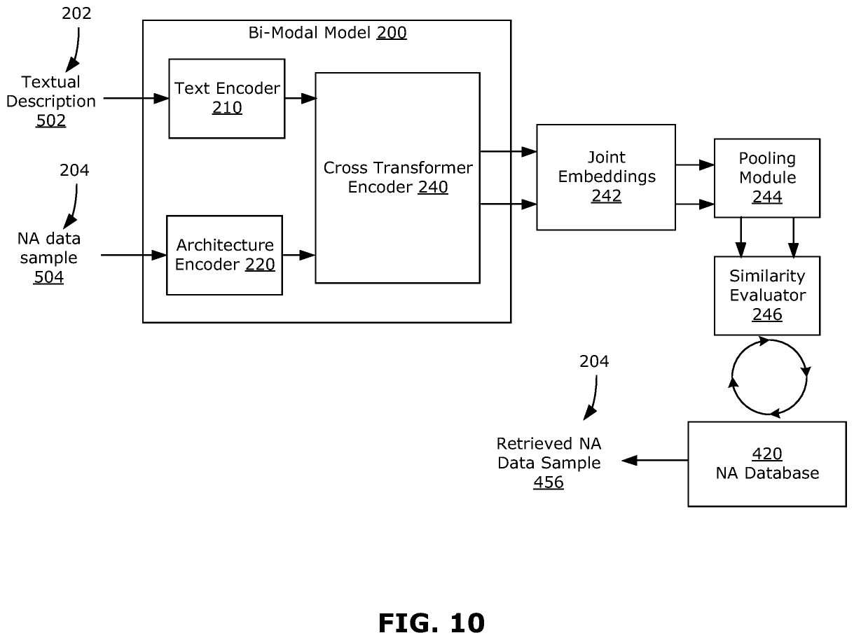

FIG. 10 is a block diagram showing operations of the bi-modal model 200 to perform a bi-modal architectural clone search task. The bi-modal architectural clone search task combines features of the architectural clone search task of FIG. 9 and the bi-modal architectural clone detection task of FIG. 8. Like the bi-modal architectural clone detection task of FIG. 8, it uses a textual description to supplement a first NA data sample.

In bi-modal architectural clone search, the trained bi-modal model 200 is used to search and find architectures that are semantically similar to an architecture given by the user, wherein a supporting additional textual description is also provided. The bi-modal architectural clone search operation is performed as the clone search operation of FIG. 9, except that a textual description 502 is provided as input along with the NA data sample 902. Instead of a cross encoded graph embedding 904, the cross transformer encoder 240 generates joint embeddings 242 of the two input data samples. The joint embeddings 242 are pooled, and the similarity evaluator 246 compares the similarity of the final encodings to each encoded representation in the NA database 420. Highly similar encoded representations are selected and their associated NA data samples are returned as inference information based on or including one or more retrieved NA data samples 456.

In some examples the retrieved NA data samples 456 are highly similar to the first neural network architecture (i.e. NA data sample 902) and the textual description 502. For example, two similarity measures may be calculated and combined, indicating the respective similarities between each of the following pairs: the first neural network architecture and the neural network architecture of the retrieved NA data sample 456, and the textual description 502 and the neural network architecture of the retrieved NA data sample 456. This combination may be performed as an average or using any other suitable technique, as described above with reference to FIG. 6A. In some examples, the overall similarity measure may indicate whether the neural network architecture of the retrieved NA data sample 456 is semantically similar to the first neural network architecture in relation to the textual description 502.

Thus, a user or querying process may use the bi-modal architectural clone search operation described above to retrieve one or more example network architectures that match an existing first network architecture and a textual description provided as input. In some examples, this may allow users to view one or more neural network architectures that may be suitable for the same tasks or applications as the known network architecture, with additional detail or additional constraints being provided by the textual description.

### GENERAL

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure, are incorporated herein by reference.

1. A method comprising:
obtaining a model trained with a bi-modal understanding of natural language in relation to neural network architectures;
providing input information to the model, the input information comprising at least one of the following:
natural language information; and
neural network architecture information; and
using the model to process the input information to generate inference information.

2. The method of claim 1, wherein the model comprises:
a text encoder to process natural language information to generate word embeddings;
a neural network architecture encoder to process neural network architecture information to generate graph encodings;
a cross transformer encoder to process word embeddings and graph encodings to generate joint embeddings;
a pooling module to pool the joint embeddings to generate encoded representations comprising fixed-size one-dimensional (1D) representations; and
a similarity evaluator for processing encoded representations to determine a similarity measure using a cosine similarity metric.

3. The method of claim 2, wherein:
the text encoder comprises:
a tokenizer to process natural language information to generate a sequence of tokens; and
a word embedder to process the sequence of tokens to generate word embeddings.

4. The method of claim 2, wherein:
the neural network architecture encoder comprises:
a graph generator to process neural network architecture information to generate a graph comprising a plurality of nodes, a plurality of edges, and a plurality of shapes;
a shape embedder to process the plurality of shapes to generate shape embeddings;
a node embedder to process the plurality of nodes to generate node embeddings;
a summation module to sum the shape embeddings and node embeddings to generate a shape-node summation; and
a graph attention network (GAT) for processing the summation and the plurality of edges to generate a graph encoding.

5. The method of claim 1, wherein obtaining the model comprises:
providing a training dataset comprising:
a plurality of positive training samples, each positive training data sample comprising neural network architecture information associated with natural language information descriptive of the neural network architecture information; and
a plurality of negative training samples, each negative training data sample comprising neural network architecture information associated with natural language information not descriptive of the neural network architecture information; and
training the model, using supervised learning, to:
maximize a similarity measure generated between the neural network architecture information and the natural language information of the positive training samples; and
minimize the similarity measure generated between the neural network architecture information and the natural language information of the negative training samples.

6. The method of claim 1:
further comprising generating a neural network architecture database by, for each of a plurality of neural network architecture information data samples:
processing the neural network architecture information data sample, using the model, to generate an encoded representation of the neural network architecture information data sample; and
storing the neural network architecture information data sample in the neural network architecture database in association with the encoded representation of the neural network architecture information data sample.

7. The method of claim 6, wherein:
the input information comprises natural language information comprising a textual description of a first neural network architecture; and
the inference information comprises neural network architecture information corresponding to a neural network architecture similar to the first neural network architecture.

8. The method of claim 7, wherein using the model to process the input information to generate the inference information comprises:
processing the input information, using the model, to generate an encoded representation of the input information;
for each of a plurality of the encoded representations of the neural network architecture information data samples of the neural network architecture database:
using the model to generate a similarity measure between the encoded representations of:
the neural network architecture information data sample; and
the input information;
selecting from the neural network architecture database a neural network architecture information data sample associated with an encoded representation having a high value of the similarity measure; and
generating the inference information based on the selected neural network architecture information data sample.

9. The method of claim 1, wherein:
the input information comprises:
natural language information comprising a textual description; and
neural network architecture information corresponding to a first neural network architecture; and
the inference information comprises Boolean information indicating whether the textual description is descriptive of the first neural network architecture.

10. The method of claim 9, wherein using the model to process the input information to generate the inference information comprises:
processing the natural language information, using the model, to generate an encoded representation of the natural language information;
processing the neural network architecture information, using the model, to generate an encoded representation of the neural network architecture information;
using the model to generate a similarity measure between the encoded representations of the neural network architecture information and the natural language information; and
generating the inference information based on the similarity measure.

11. The method of claim 1:
further comprising generating an answer database by, for each of a plurality of answer data samples, each answer data sample comprising natural language information:
processing the answer data sample, using the model, to generate an encoded representation of the answer data sample; and
storing the answer data sample in the neural network architecture database in association with the encoded representation of the answer data sample.

12. The method of claim 11, wherein:
the input information comprises:
natural language information comprising a question; and
neural network architecture information corresponding to a first neural network architecture; and
the inference information comprises an answer data sample selected from the answer database, the selected answer data sample being responsive to the question.

13. The method of claim 12, wherein using the model to process the input information to generate the inference information comprises:
processing the neural network architecture information and natural language information, using the model, to generate a joint encoded representation of the neural network architecture information and natural language information;
for each of a plurality of the encoded representations of the answer data samples of the answer database:
using the model to generate a similarity measure between:
the encoded representation of the answer data sample; and
the joint encoded representation of the neural network architecture information and natural language information;
selecting from the answer database an answer data sample associated with an encoded representation having a high value of the similarity measure; and
generating the inference information based on the selected answer data sample.

14. The method of claim 11, wherein:
the input information comprises:
a first neural network architecture information data sample corresponding to a first neural network architecture; and
a second neural network architecture information data sample corresponding to a second neural network architecture;
the inference information comprises similarity information indicating a degree of semantic similarity between the first neural network architecture and the second neural network architecture.

15. The method of claim 14, wherein using the model to process the input information to generate the inference information comprises:
processing the first neural network architecture information data sample, using the model, to generate an encoded representation of the first neural network architecture information data sample;
processing the second neural network architecture information data sample, using the model, to generate an encoded representation of the second neural network architecture information data sample;
using the model to generate a similarity measure between the encoded representations of the first neural network architecture information data sample and the second neural network architecture information data sample; and
generating the inference information based on the similarity measure.

16. The method of claim 15, wherein:
the input information further comprises natural language information comprising a textual description;
using the model to process the input information to generate the inference information further comprises:
processing the natural language information, using the model, to generate an encoded representation of the natural language information;
the similarity measure is generated based on a similarity among the encoded representations of the first neural network architecture information data sample, the second neural network architecture information data sample, and the natural language information; and
the inference information indicates whether the first neural network architecture and the second neural network architecture are semantically similar in relation to the textual description.

17. The method of claim 6, wherein:
the input information comprises neural network architecture information corresponding to a first neural network architecture; and
the inference information comprises neural network architecture information corresponding to a neural network architecture semantically similar to the first neural network architecture.

18. The method of claim 6, wherein:
the input information comprises:
neural network architecture information corresponding to a first neural network architecture; and
natural language architecture information comprising a textual description; and
the inference information comprises neural network architecture information corresponding to a neural network architecture semantically similar to the first neural network architecture in relation to the textual description.

19. A method comprising:
obtaining input information comprising at least one of the following:
natural language information; and
neural network architecture information; and
transmitting the input information to a system comprising a model trained with a bi-modal understanding of natural language in relation to neural network architectures; and
receiving inference information generated by the model by processing the input information.

20. A non-transitory computer-readable medium having instructions tangibly stored thereon that, when executed by a processing system, cause the processing system to perform the method of claim 1.
